(19) United States
(12) Patent Application Publication
(10) Pub. No.: US 2020/0243930 A1
(43) Pub. Date: Jul. 30, 2020

(54) TEMPERATURE CONTROL DEVICE OF AN ELECTRICAL ENERGY STORAGE UNIT

(71) Applicant: Robert Bosch GmbH, Stuttgart (DE)

(72) Inventors: Michael Raedler, Hamburg (DE); Markus Kohlberger, Stuttgart (DE); Reiner Ramsayer, Rutesheim (DE)

(21) Appl. No.: 15/768,896

(22) PCT Filed: Oct. 7, 2016
(86) PCT No.: PCT/EP2016/073980

§ 371 Date: Apr. 17, 2018

(30) Foreign Application Priority Data
Oct. 20, 2015 (DE) 10 2015 220 434.0

(51) Int. Cl. H01M 10/656; H01M 10/625; H01M 10/63; H01M 10/613

(52) U.S. Cl. CPC H01M 10/656; H01M 10/613; H01M 10/63; H01M 10/625

(57) ABSTRACT

The invention relates to a temperature control device (10) of an electrical energy storage unit (42), comprising a fluid-based cooling circuit, wherein the temperature control device (10) has a fluid reservoir (14), which is connected to the cooling circuit by means of a shut-off element (11) and is at least partially surrounded by thermal insulation (15). The invention further relates to a method for operating a temperature control device (10), and to an electrical energy storage system.

### BACKGROUND OF THE INVENTION

The present invention is based on a temperature-control device of an electrical energy storage unit, on a method for operating a temperature-control device of an electrical energy storage unit, and on an electrical energy storage system.

The temperature management of batteries, in particular of batteries which are installed in an automobile, is an important aspect since it can decisively influence the increase in reliability, performance and service life of the batteries. Consequently, the further development of this technology is of major importance, also from the viewpoint that future batteries will possibly have to be operated at a higher temperature level than is the case with the lithium-ion technology which is currently often used. In the case of these so-called high-temperature batteries, the temperature management is a particular challenge since the operating temperature of said batteries is typically well above the ambient temperature. However, even batteries based on lithium-ion technology, in particular if they are used at low temperatures below the freezing point, require corresponding temperature management.

A battery whose housing is partially filled with cooling fluid is described in document DE 10 2009 006 426 A1.

Document DE 10 2011 075 462 A1 describes a battery module, wherein the cells which form the battery module are contacted by at least one phase-change-material-containing cell.

Document WO 2011/105256 A1 discloses a battery whose battery cells are surrounded at least partially by a cooling liquid.

A battery module with oil cooling is described in document US 2013/0260195 A1.

Document DE 10 2009 006 216 A1 describes a cooling device for electrical elements, wherein a grid-like structure is arranged between the cells.

Liquid cooling for a high-temperature battery is described in document DE 43 09 070 A1.

### SUMMARY OF THE INVENTION

Provided according to the invention is a temperature-control device of an electrical energy storage unit, a method for operating a temperature-control device of an electrical energy storage unit, a battery system with the same temperature-control device, and/or means for carrying out the same method.

In this case, the temperature-control device comprises a fluid-based cooling circuit, wherein the temperature-control device has a fluid storage container which is connected to the cooling circuit via a shut-off element and which is surrounded by thermal insulation. It is thus possible for the fluid storage container to be connected to the cooling circuit or separated therefrom depending on the requirements, which allows targeted storage and delivery of fluid. Here, the shut-off element may be designed for example as a shut-off slide, shut-off flap or valve. The insulation ensures that a fluid contained in the fluid storage container is able to store the thermal energy, which has been supplied to it by way of a heating process, over a long time since only relatively low heat dissipation to the surroundings occurs. Consequently, the expenditure for the warming of the circulating fluid is reduced and a starting phase of a battery connected to the cooling circuit can be shortened considerably if fluid whose temperature is already correctly controlled can circulate in the cooling circuit without a pre-warming phase for the fluid being necessary. Likewise, it is possible for a correspondingly cooled fluid to be stored in the fluid storage container in order to protect it from being warmed up by way of elevated ambient temperatures. In this case, the term “cooling circuit” refers to a circuit inside the temperature-control device, which circuit is suitable both for the cooling and for the warming of, put in general terms for controlling the temperature of, an electrical energy storage unit.

Further advantageous embodiments of the present invention form the subject matter of the dependent claims.

It is thus advantageous if the shut-off element is designed as a valve. This allows a uniform flow pattern in the flow cross section to be achieved.

According to a further aspect, it may be provided that the fluid storage container is set up for receiving almost completely a fluid used in the cooling circuit. This advantageously allows the fluid to be stored in a container which typically has a significantly smaller size or surface area than a battery system. Consequently, firstly it is possible for the expenditure for insulation inside the pack to be reduced since the warmed fluid can be stored in the insulated container, and secondly, at the start of operation, the required temperature-controlled fluid is provided more quickly than if it were first to have to be heated up. Likewise, it is possible for a correspondingly cooled fluid to be stored almost completely in the fluid container in order to protect said fluid from being warmed up by way of elevated ambient temperatures, wherein the advantages discussed apply in an analogous manner. Since complete receiving of the fluid by the fluid storage container would be technically very complex or difficult to be able to realize, almost complete receiving by the fluid storage container is expedient. This means, for example, that the container is able to receive 80 to 100 percent of the fluid used in the cooling circuit.

The fluid storage container expediently comprises a heating element. This allows the fluid in the fluid storage container to be brought to a required operating temperature quickly, which is relevant in particular for high-temperature batteries.

Furthermore, the temperature-control device may be designed such that the fluid storage container comprises a heat exchanger. This allows the fluid stored in the fluid storage container to be cooled or heated. It is also possible for a simple connection of the temperature-control device to an already existing temperature-control device, for example the temperature-control circuit of an air-conditioning unit in an automobile, to be realized.

The fluid used in the cooling circuit is advantageously a dielectric fluid. It is thus possible, for example, for the electrical energy storage unit to be completely surrounded by the fluid, or for the fluid to be passed in direct contact via connecting elements or terminal connections of the energy storage unit, without an electrical short-circuit occurring. For example, oils or paraffins may be used here as a dielectric fluid.

According to a further aspect, it may be provided that at least one connecting element, for example for electrically connecting electrical energy storage units, is mounted at least partially inside the cooling circuit of the temperature-control device. Consequently, the connecting element is in direct contact with the fluid which is present in the cooling circuit, and heat can be effectively discharged or supplied. The fact that the connecting element is arranged inside the cooling circuit without spatial proximity to an electrical energy storage unit means that the reliability of the temperature-control system is increased, and that additional flexibility is achieved during production. For example, it is possible for corresponding fluid lines with integrated connecting elements to be produced, and for the connecting elements to be subsequently connected to the electrical energy storage units by means of a type of “clip process”.

It may furthermore be provided that at least that part of a connecting element, said element being realized for example in the form of a cell connector, which is mounted inside the cooling circuit has an additional, electrically insulating surface coating. This allows the insulation with respect to current flow to be increased. It is thus also possible, for example, for a certain conductivity of the fluid used to be compensated.

The invention also relates to a method for operating a temperature-control device of an electrical energy storage unit, comprising a fluid-based cooling circuit, wherein, when the use of the electrical energy storage unit is below a defined power level, a fluid used in the cooling circuit is supplied almost completely to a thermally insulated fluid storage container. It is thus possible, for example, in the case of non-use of the electrical energy storage unit, or only very low use, for the fluid supplied to the container to be advantageously maintained at an elevated temperature without heat having to be actively supplied to said fluid. The method may be used advantageously in particular in the case of parking or shutdown of a vehicle, having an electrical energy storage unit and the described temperature-control device, overnight. Even if only quiescent current requirements are to be satisfied, that is to say for example only a control unit is to be provided with a supply, it can be advantageous to supply to the thermally insulated fluid storage container the fluid used in the cooling circuit. The advantages of the device which are mentioned further above apply in the same way.

According to a further aspect, if necessary, the temperature of the fluid stored in the fluid storage container may be controlled by way of a heating element and/or a heat exchanger. Here, a necessity can exist if, after a prolonged period of use below a defined power level, a higher power is retrieved, or should be retrieved, again from the electrical energy storage unit. In this case, it is advantageous if the temperature control occurs inside a thermally insulated container since, in this way, a temperature-control process can be realized more quickly than is the case with a fluid which is distributed inside the cooling circuit. The advantages of the device which are mentioned further above apply in the same way.

The invention also relates to a battery system which comprises at least two electrical energy storage units and which is equipped with the temperature-control device according to the invention or with means for carrying out the method according to the invention. The battery system thus offers in particular shortened starting times until a desired power can be retrieved and an optimal temperature control of the energy storage units, which increases the system service life and the achievable power. The means for carrying out the method according to the invention may comprise for example a cooling circuit with a fluid, a pump in the cooling circuit, at least one shut-off element, such as a valve, and/or a control unit. In this case, the control unit receives suitable signals, processes these and controls connected actuators such as the pump or the shut-off element.

According to a further concept, at least one electrical energy storage unit of the battery system is surrounded at least partially by the fluid used in the cooling circuit. It is thus possible via the direct contact between the energy storage unit and the fluid, which in particular circulates inside the cooling circuit, for very good temperature control of the energy storage unit to be achieved.

An “electrical energy storage unit” can be understood to mean in particular an electrochemical battery cell and/or a battery module composed of two or more electrochemical battery cells and/or a battery pack composed of two or more battery modules. For example, the electrical energy storage unit may be a lithium battery cell or a lithium battery module or a lithium battery pack. In particular, the electrical energy storage unit may be a lithium-ion battery cell or a lithium-ion battery module or a lithium-ion battery pack. Furthermore, the battery cell may be of the lithium-polymer accumulator, nickel-metal hydride accumulator, lead-acid accumulator, lithium-air accumulator or lithium-sulfur accumulator type, or quite generally an accumulator of any electrochemical composition.

### BRIEF DESCRIPTION OF THE DRAWINGS

In the drawings:

FIG. 1 shows a schematic illustration of a temperature-control device according to the invention as per a first exemplary embodiment,

FIG. 2 shows a schematic illustration of a temperature-control device according to the invention as per a second exemplary embodiment,

FIG. 3 shows a schematic illustration of a temperature-control device according to the invention as per a third exemplary embodiment,

FIG. 4 shows a schematic illustration of multiple connecting elements, arranged inside a cooling circuit of a temperature-control device, for battery cells, and

FIG. 5 shows a flow diagram of a method according to the invention as per a first exemplary embodiment.

### DETAILED DESCRIPTION

In all the figures, the same reference signs are used to denote identical device components.

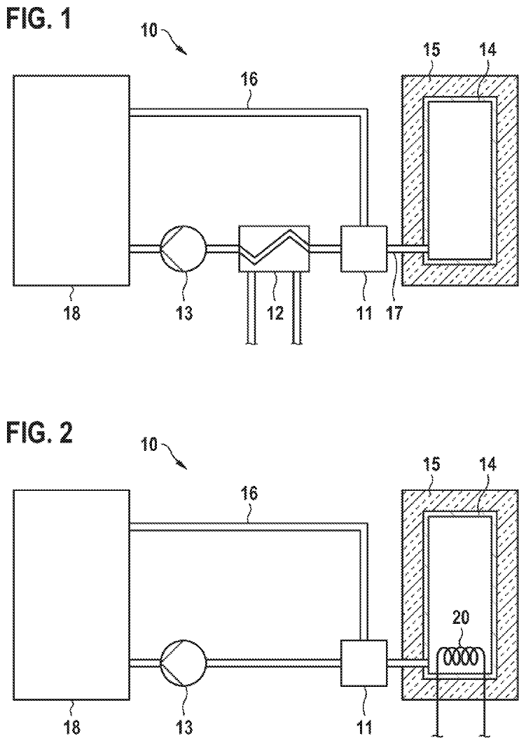

FIG. 1 schematically shows, as per a first exemplary embodiment, a temperature-control device 10 which comprises a cooling circuit and which is connected, for example via suitable fluid lines 16, to an electrical energy storage unit 18. The fluid storage container 14, which is surrounded by thermal insulation 15, is connected to the cooling circuit via a valve 11. The fluid circulating in the cooling circuit may in this case be a gas or a liquid, for example a water/glycol mixture. When the thermally-insulated fluid storage container is connected, it is advantageous to design the connecting line 17 between the valve 11 and the fluid storage container 14 to be short in order to minimize possible heat losses. For the purpose of warming or cooling the fluid circulating in the cooling circuit, a heat exchanger 12 is integrated into the cooling circuit. A pump 13 in the cooling circuit circulates the fluid. Corresponding control commands can be transmitted for example by a control unit (which is not shown in FIG. 1).

FIG. 2 schematically illustrates a second exemplary embodiment of a temperature-control device 10 according to the invention. In this case, a heating element 20 is integrated into the fluid storage container 14 having the surrounding thermal insulation 15. It is thus possible, for example, for a liquid used in the cooling circuit to be warmed up or heated up quickly. This is advantageous in particular in the case of a prolonged period of non-use, such as for example in the case of a shutdown of a vehicle, having the temperature-control device, overnight, since the time until the start of operation can be reduced.

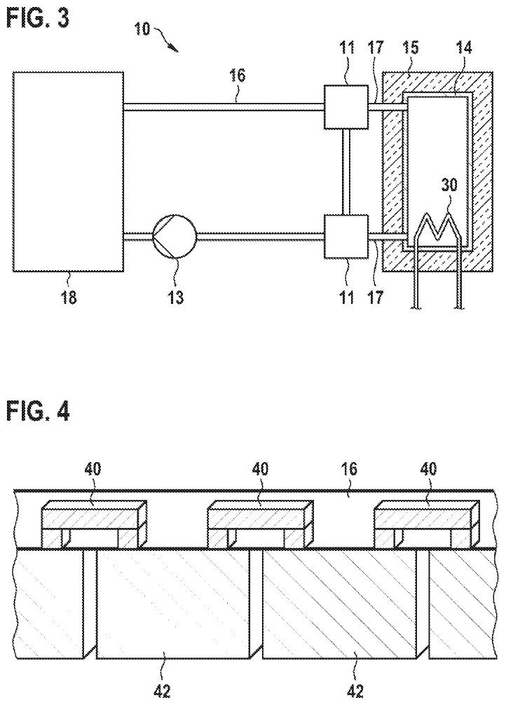

FIG. 3 schematically shows a temperature-control device 10 as per a third exemplary embodiment. In this case, the thermally insulated fluid storage container 14 is connected to the fluid lines 16 of the cooling circuit via two valves 11. For example, it is thus possible for relatively simple valves to be used, and/or for the inflow and outflow of fluid to be regulated in a relatively simple manner. A heat exchanger 30 is integrated into the fluid storage container 14. This allows the fluid stored there to be cooled, or warmed up or heated up, quickly.

The heat exchanger 12 installed into the cooling circuit may in this case also be combined with the heat exchanger 30 which is installed into the fluid storage container 14 and also with the heating element 20, with the result that it is possible to supply or discharge heat both via the cooling circuit and via the fluid storage container. It is likewise possible to additionally integrate a heating element into the cooling circuit, for example instead of the heat exchanger.

FIG. 4 schematically illustrates multiple connecting elements 40 arranged inside a fluid line 16 of a cooling circuit of a temperature-control device 10. The connecting elements 40 electrically connect battery cells 42 in each case to the neighbors of said cells. The connecting elements 40 are designed here as cell connectors. Here, the fluid line 16 may consist of individual fluid line segments, wherein the fluid line segments are produced from half shells. The connecting elements 40 are introduced into the half shells in a fluid-tight manner, that is to say their connection points to the outside are sealed off in a fluid-tight manner. The half shells are subsequently connected to one another in a fluid-tight manner. This may be realized for example via a materially cohesive connection process, such as welding or soldering. As a result of fluid-tight connection of multiple fluid line segments, it is thus possible for the cooling circuit of the temperature-control device to be built up in a simple manner.

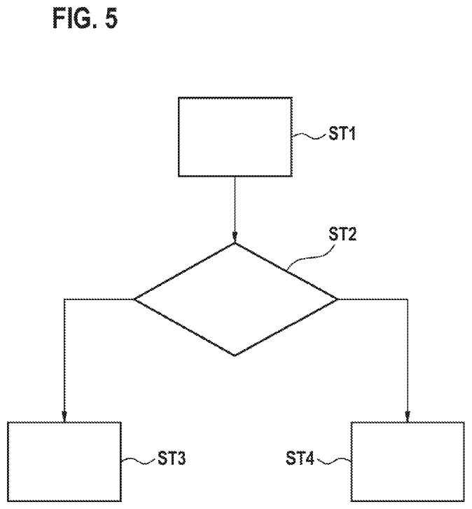

FIG. 5 illustrates a flow diagram of a method according to the invention as per a first exemplary embodiment. In a first step ST1, the use of the electrical energy storage unit is determined. In a second step ST2, it is decided whether the use is below or above a defined power level. If the use is below, in a third step ST3, the fluid used in the cooling circuit is supplied almost completely to a fluid storage container which is surrounded at least partially by thermal insulation. If the use is above a defined power level, in a fourth step ST4, the fluid remains in the cooling circuit. The method may be performed at periodic intervals or in an event-based manner, for example when deactivating the ignition.

1. A temperature-control device (10) of an electrical energy storage unit (18, 42), the temperature-control device comprising a fluid-based cooling circuit, and a fluid storage container (14) which is connected to the cooling circuit via a shut-off element (11) and which is surrounded at least partially by thermal insulation (15).

2. The temperature-control device (10) as claimed in claim 1, characterized in that the shut-off element is a valve (11).

3. The temperature-control device (10) as claimed in claim 1, characterized in that the fluid storage container (14) is configured for receiving almost completely a fluid used in the cooling circuit.

4. The temperature-control device (10) as claimed in claim 1, characterized in that the fluid storage container (14) comprises a heating element (20).

5. The temperature-control device (10) as claimed in claim 1, characterized in that the fluid storage container (14) comprises a heat exchanger (30).

6. The temperature-control device (10) as claimed in claim 1, characterized in that a fluid used in the cooling circuit is a dielectric fluid.

7. The temperature-control device (10) as claimed in claim 1, characterized in that at least one connecting element (40) for electrical energy storage units (18, 42) is mounted at least partially inside a fluid line (16) of the cooling circuit of the temperature-control device (10).

8. The temperature-control device (10) as claimed in claim 7, characterized in that at least that part of the at least one connecting element (40) which is mounted inside the fluid line (16) of the cooling circuit has an additional surface coating.

9. A method for operating a temperature-control device (10) of an electrical energy storage unit (18, 42), the temperature-control device comprising a fluid-based cooling circuit, that the method comprising, when use of the electrical energy storage unit (18, 42) is below a defined power level, supplying a fluid used in the cooling circuit almost completely to a fluid storage container (14) which is surrounded at least partially by thermal insulation (15).

10. The method as claimed in claim 9, characterized in that, if necessary, the temperature of the fluid stored in the thermally insulated fluid storage container (14) is controlled by way of a heating element (20) and/or a heat exchanger (30).

11. An electrical energy storage system comprising at least one electrical energy storage unit (18, 42), wherein the electrical energy storage system comprises a temperature-control device (10) as claimed in claim 1.

12. The electrical energy storage system as claimed in claim 11, characterized in that at least one electrical energy storage unit (18, 42) is surrounded at least partially by the fluid used in the cooling circuit.

13. (canceled)

14. An electrical energy storage system comprising at least one electrical energy storage unit (18, 42), wherein the electrical energy storage system comprises means for carrying out the method as claimed in claim 9.

15. The electrical energy storage system as claimed in claim 14, characterized in that at least one electrical energy storage unit (18, 42) is surrounded at least partially by the fluid used in the cooling circuit.

16. The electrical energy storage system as claimed in claim 14, characterized in that, if necessary, the temperature of the fluid stored in the thermally insulated fluid storage container (14) is controlled by way of a heating element (20) and/or a heat exchanger (30).
